(19) United States
(12) Patent Application Publication
(10) Pub. No.: US 2016/0154280 A1
(43) Pub. Date: Jun. 2, 2016

(54) LIQUID CRYSTAL DISPLAY

(71) Applicant: Samsung Display Co., Ltd., Yongin-si (KR)

(72) Inventors: Seung Ho YANG, Hwaseong-si (KR); Su Wan WOO, Osan-si (KR)

(21) Appl. No.: 14/833,517

(22) Filed: Aug. 24, 2015

(30) Foreign Application Priority Data
Nov. 27, 2014 (KR) 10-2014-0167433

(51) Int. Cl. G02F 1/1343; G02F 1/1335; G02F 1/1362

(52) U.S. Cl. CPC G02F 1/134309; G02F 1/136286; G02F 1/133528; G02F 2001/134345; G02F 2001/133531

(57) ABSTRACT

A liquid crystal display includes a first substrate, a gate line disposed on the first substrate, an insulating layer disposed on the gate line, and a pixel electrode disposed on the insulating layer, the pixel electrode including diagonal stems forming a cross shape with each other, and minute branches extending in four different directions from the diagonal stems, in which the minute branches extend in first and second directions to form an angle of 80 degrees to 100 degrees with respect to an extension direction of the gate line, and the minute branches extend in third and fourth directions to form an angle of −10 degrees to 10 degrees with respect to the extension direction of the gate line.

### CROSS-REFERENCE TO RELATED APPLICATION

This application claims priority from and the benefit of Korean Patent Application No. 10-2014-0167433, filed on Nov. 27, 2014, which is hereby incorporated by reference for all purposes as if fully set forth herein.

### BACKGROUND

1. Field

Exemplary embodiments of the present invention relate to a liquid crystal display including minute branches in a pixel electrode.

2. Discussion of the Background

A liquid crystal display, which may include two sheets of display panels with field generating electrodes, such as a pixel electrode and a common electrode, and a liquid crystal layer interposed therebetween. The liquid crystal display may generate an electric field in the liquid crystal layer by applying a voltage to the field generating electrodes to align liquid crystal molecules of the liquid crystal layer and control polarization of incident light to display images.

Among the liquid crystal displays, a vertically aligned mode liquid crystal display, in which long axes of the liquid crystal molecules are aligned perpendicular to the upper and lower panels when the electric field is not applied, has been studied because it may have a large contrast ratio and easily implement a wide reference viewing angle.

To implement a wide viewing angle in the vertically aligned mode liquid crystal display, domains having different alignment directions of the liquid crystal molecules may be formed in one pixel.

To form the domains, cutouts such as minute slits may be formed in the field generating electrode, or protrusions may be formed on the field generating electrode. The domains may be formed by aligning the liquid crystal molecules in a direction perpendicular to a fringe field generated by edges of the cutouts or the protrusions and the field generating electrodes that face the edges of the cutouts or the protrusions.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a liquid crystal display including minute branches in a pixel electrode formed in vertical and horizontal directions, to prevent generating a texture when the liquid crystal display is bent.

Additional aspects will be set forth in the detailed description which follows, and, in part, will be apparent from the disclosure, or may be learned by practice of the inventive concept.

According to exemplary embodiments of the present invention, a liquid crystal display includes a first substrate, a gate line disposed on the first substrate, an insulating layer disposed on the gate line, and a pixel electrode disposed on the insulating layer, the pixel electrode including diagonal stems forming a cross shape with each other, and minute branches extending in four different directions from the diagonal stems, in which the minute branches extend in first and second directions to form an angle of 80 degrees to 100 degrees with respect to an extension direction of the gate line, and the minute branches extend in third and fourth directions to form an angle of −10 degrees to 10 degrees with respect to the extension direction of the gate line.

The pixel electrode may include a first subpixel electrode and a second subpixel electrode spaced apart from each other.

The first subpixel electrode may be disposed above the gate line and the second subpixel may be disposed below the gate line.

An area of the second subpixel electrode may be greater than an area of the first subpixel electrode.

The first subpixel electrode may include the diagonal stems forming one cross shape, the second subpixel electrode may include the diagonal stems forming two cross shapes, and the diagonal stems forming each cross shape may cross each other perpendicularly at a crossing point.

The diagonal stems may divide the pixel electrode into a first region, a second region, a third region, and a fourth region, and the minute branches in the regions that face each other with respect to the diagonal stems may extend in the same direction.

The minute branches in the first and third regions may be disposed in the same direction, the minute branches in the second and fourth regions may be disposed in the same direction, and the minute branches of the first and second regions may be disposed to be perpendicular to each other.

The liquid crystal display may further include a second substrate disposed to face the first substrate, a common electrode disposed on the second substrate, and a liquid crystal layer disposed between the first substrate and the second substrate.

The liquid crystal display may further include a lower polarizer disposed below the first substrate, and an upper polarizer disposed above the second substrate.

A transmissive axis of the lower polarizer may be substantially parallel to a first extending direction of the diagonal stems, a transmissive axis of the upper polarizer may be substantially parallel to a second extending direction of the diagonal stems, and the transmissive axes of the lower and upper polarizers may cross each other to form an X shape.

The transmissive axis of the lower polarizer and the minute branches may form an angle of 45 degrees.

The transmissive axis of the upper polarizer and the minute branches may form an angle of 45 degrees.

The transmissive axis of the upper polarizer and the transmissive axis of the lower polarizer may perpendicularly cross each other.

The liquid crystal display may be a curved display.

The first subpixel electrode may be configured to receive a first voltage and the second subpixel electrode may be configured to receive a second voltage different from the first voltage.

The first subpixel electrode may be configured to receive a first voltage and the second subpixel electrode may be configured to receive a second voltage lower than the first voltage.

Each edge of the minute branches may be connected to an outer edge stem.

The two cross shapes disposed in the second subpixel electrode may have the same shape with each other and are spaced apart by a horizontal stem forming an angle of 45 degrees with the diagonal stems.

A width of each minute branches may be in a range of 2.5 μm to 5.0 μm.

A distance between minute branches extending in the same direction may be in a range of 2.5 μm to 5.0 μm.

In the liquid crystal display according to the exemplary embodiment of the present invention, the pixel electrode may include minute branches, and the minute branches may be disposed in vertical and horizontal directions, to prevent generation of a texture when the liquid crystal display is bent.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a circuit diagram of one pixel in a liquid crystal display according to an exemplary embodiment of the present invention.

FIG. 2 is a layout view of the pixel of the liquid crystal display according to the exemplary embodiment of FIG. 1.

FIG. 3 is a cross-sectional view of the liquid crystal display of FIG. 2, taken along the line III-III.

FIG. 4 is a top plan view of a pixel electrode of the liquid crystal display according to the exemplary embodiment of FIG. 2.

FIG. 5 shows a process of pre-tilting liquid crystal molecules using a pre-polymer polymerized by light.

FIG. 6 shows transmissive axes of lower and upper polarizers of the liquid crystal display according to the exemplary embodiment of FIGS. 2 and 4.

FIG. 7 is a layout view of a liquid crystal display according to a comparative exemplary embodiment.

FIG. 8 is a diagram illustrating a misalignment and generated texture when the liquid crystal display of FIG. 7 is bent.

FIG. 9 is an image of the texture generated in the liquid crystal display according to the comparative exemplary embodiment of FIG. 7.

FIG. 10 is a layout view of a pixel of a liquid crystal display according to an exemplary embodiment of the present invention.

FIG. 11, FIG. 12, FIG. 13, and FIG. 14 are circuit diagrams of a pixel according to exemplary embodiments of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

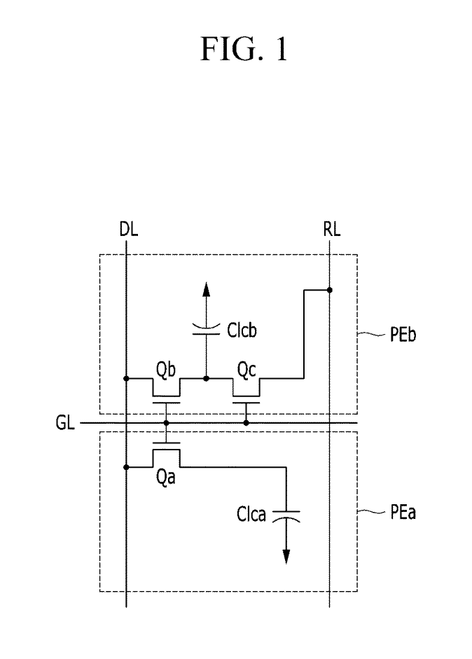

Referring to FIG. 1, a layout and a driving method of signal lines and pixels of a liquid crystal display according to an exemplary embodiment of the present invention will be described. FIG. 1 is a circuit diagram of one pixel of the liquid crystal display according to the exemplary embodiment of the present invention.

Referring to FIG. 1, a pixel PX may include signal lines including a gate line GL transmitting a gate signal, a data line DL transmitting a data signal, a divided reference voltage line RL transmitting a divided reference voltage, first, second, and third switching elements Qa, Qb, and Qc connected to the signal lines, and first and second liquid crystal capacitors Clca and Clcb.

The first and second switching elements Qa and Qb are respectively connected to the gate line GL and the data line DL, and the third switching element Qc is connected to an output terminal of the second switching element Qb and the divided reference voltage line RL.

The first switching element Qa and the second switching element Qb may be three-terminal elements such as thin-film transistors. Control terminals of the first and second switching elements Qa and Qb are connected to the gate line GL, input terminals thereof are connected to the data line DL, an output terminal of the first switching element Qa is connected to the first liquid crystal capacitor Clca, and an output terminal of the second switching element Qb is connected to the second liquid crystal capacitor Clcb and an input terminal of the third switching element Qc.

The third switching element Qc may also be a three-terminal element such as a thin-film transistor. A control terminal of the third switching element Qc may be connected to the gate line GL, an input terminal thereof is connected to the second liquid crystal capacitor Clcb, and an output terminal thereof is connected to the divided reference voltage line RL.

When a gate on signal is applied to the gate line GL, the first switching element Qa, the second switching element Qb, and the third switching element Qc connected thereto may be turned on. Thus, a data voltage applied to the data line DL is applied to a first subpixel electrode PEa and a second subpixel electrode PEb through the turned-on first and second switching elements Qa and Qb. In this case, the data voltage applied to the first subpixel electrode PEa and the data voltage applied to the second subpixel electrode PEb may be equivalent to each other, and the first liquid crystal capacitor Clca and the second liquid crystal capacitor Clcb may be equally charged with a voltage level difference between a common voltage and the data voltage. Simultaneously, a voltage charged to the second liquid crystal capacitor Clcb is divided through the turned-on third switching element Qc. Thus, a voltage charged to the second liquid crystal capacitor Clcb is decreased by a voltage level difference between the common voltage and the divided reference voltage. More particularly, a voltage charged in the first liquid crystal capacitor Clca may become higher than the voltage charged to the second liquid crystal capacitor Clcb.

As described, the voltage charged to the first liquid crystal capacitor Clca and the voltage charged to the second liquid crystal capacitor Clcb may become different from each other. When the voltage of the first liquid crystal capacitor Clca and the voltage of the second liquid crystal capacitor Clcb are different from each other, liquid crystal molecules in the first subpixel and the liquid crystal molecules in the second subpixel may be tilted with different angles, and accordingly, luminances of the two subpixels may be different from each other. Accordingly, when the voltage of the first liquid crystal capacitor Clca and the voltage of the second liquid crystal capacitor Clcb are controlled, an image viewed from a side of the liquid crystal display may substantially be similar to an image viewed from the front, thereby improving side visibility.

According to an exemplary embodiment of the present invention, the second liquid crystal capacitor Clcb may be connected to a step-down capacitor to vary the charged voltages in the first and second liquid crystal capacitors Clca and Clcb. In detail, the third switching element Qc may include a first terminal connected to a step-down gate line, a second terminal connected to the second liquid crystal capacitor Clcb, and a third terminal connected to the step-down capacitor. Accordingly, a portion of charged amount in the second liquid crystal capacitor Clcb may be charged in the step-down capacitor to vary the charged voltages between the first liquid crystal capacitor Clcb and the second liquid crystal capacitor Clcb.

Alternatively, the first liquid crystal capacitor Clcb and the second liquid crystal capacitor Clcb may be connected to different data lines DL, respectively, to receive different data voltages. Accordingly, the charged voltages between the first liquid crystal capacitor Clca and the second liquid crystal capacitor Clcb may be set differently. In addition, the charged voltages between the first liquid crystal capacitor Clca and the second liquid crystal capacitor Clcb may be set differently by various different methods.

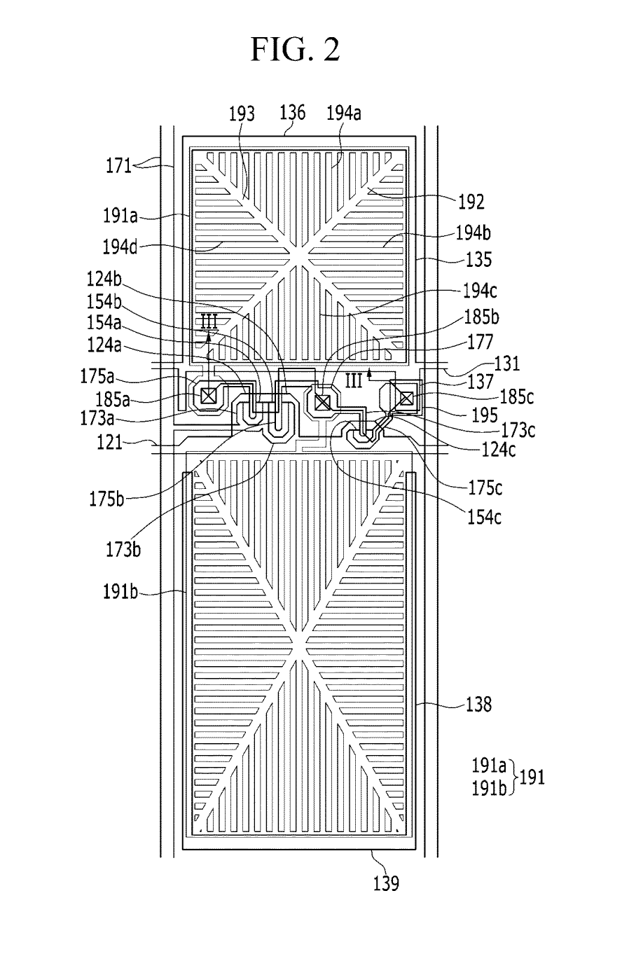

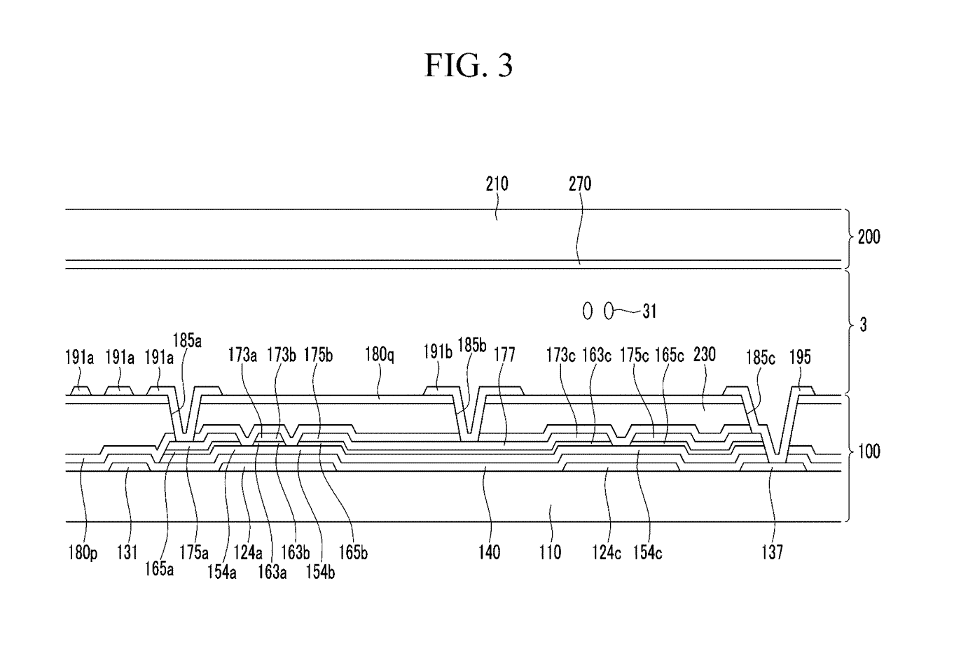

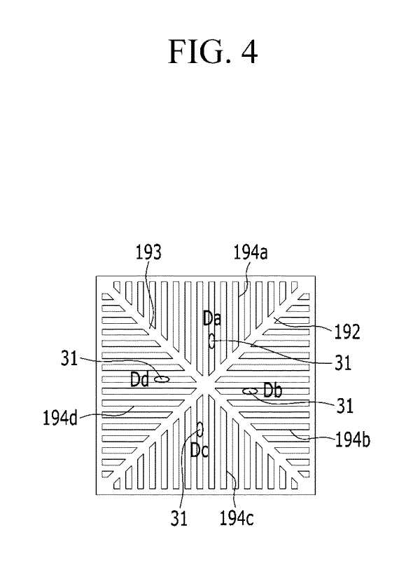

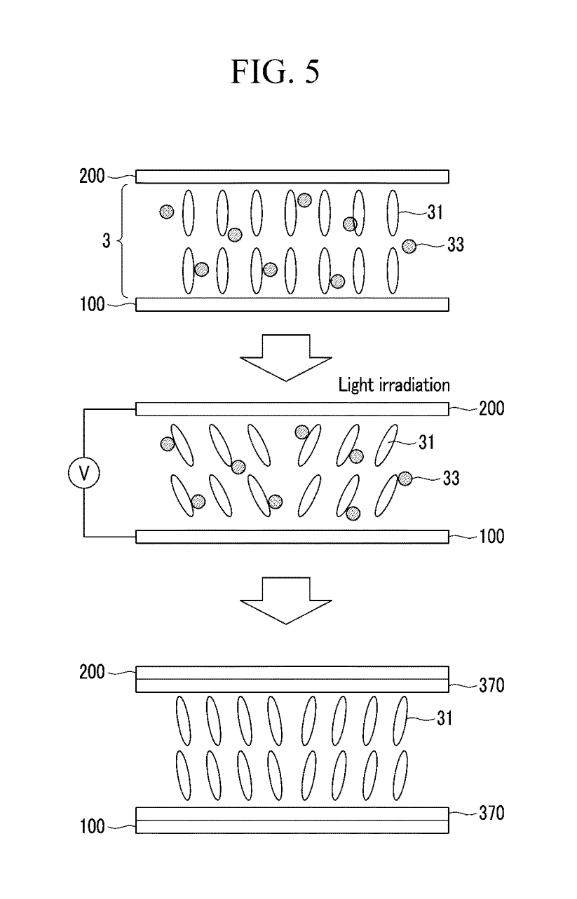

Next, a structure of the liquid crystal display illustrated in FIG. 1 will be described with reference to FIG. 2 to FIG. 5. FIG. 2 is a layout view of one pixel of the liquid crystal display according to the exemplary embodiment of the present invention, and FIG. 3 is a cross-sectional view of the liquid crystal display of FIG. 2, taken along the line III-III. FIG. 4 is a top plan view of a pixel electrode of the liquid crystal display according to the exemplary embodiment of the present invention, and FIG. 5 shows a process of pre-tilting the liquid crystal molecules using a pre-polymer polymerized by light, such as ultraviolet light.

Referring to FIG. 2 and FIG. 3, the liquid crystal display according to the present exemplary embodiment includes lower and upper panels 100 and 200 that face each other, a liquid crystal layer 3 provided between the lower panel 100 and the upper panel 200, and a pair of polarizers (not shown) attached to the outer sides of the lower and upper panels 100 and 200.

Hereinafter, the lower panel 100 will be described.

A gate conductor including a gate line 121 and a divided reference voltage line 131 is formed on an insulation substrate 110 that includes transparent glass or plastic.

The gate line 121 includes a wide end portion (not shown) to contact with a first gate electrode 124a, a second gate electrode 124b, a third gate electrode 124c, and another layer or an external driving circuit.

The divided reference voltage line 131 includes first storage electrodes 135 and 136, and a reference electrode 137. Second storage electrodes 138 and 139 that overlap a second subpixel electrode 191b may not be connected to the divided reference voltage line 131.

A gate insulating layer 140 is formed on the gate line 121 and the divided reference voltage line 131.

A first semiconductor 154a, a second semiconductor 154b, and a third semiconductor 154c are formed on the gate insulating layer 140.

Ohmic contacts 163a, 165a, 163b, 165b, 163c, and 165c are formed on the semiconductors 154a, 154b, and 154c.

Data lines 171 including a first source electrode 173a and a second source electrode 173b, and data conductors including a first drain electrode 175a, a second drain electrode 175b, a third source electrode 173c, and a third drain electrode 175c are formed on the ohmic contacts 163a, 165a, 163b, 165b, 163c, and 165c and the gate insulating layer 140.

The data conductors 171, 173c, 175a, 175b, and 175c and the semiconductors 154a, 154b, and 154c positioned below the data conductors 171, 173c, 175a, 175b, and 175c, and the ohmic contacts 163a, 165a, 163b, 165b, 163c, and 165c may be simultaneously formed by using one mask.

The data line 171 includes a wide end portion (not shown) to contact another layer or an external driving circuit.

The first gate electrode 124a, the first source electrode 173a, and the first drain electrode 175a form a first thin-film transistor (TFT) Qa together with the first semiconductor 154a. A channel of the thin-film transistor Qa is formed in the first semiconductor 154a between the first source electrode 173a and the first drain electrode 175a. Similarly, the second gate electrode 124b, the second source electrode 173b, and the second drain electrode 175b form a second thin-film transistor Qb together with the second semiconductor 154b. A channel of the second thin-film transistor Qb is formed in the second semiconductor 154b between the second source electrode 173b and the second drain electrode 175b. The third gate electrode 124c, the third source electrode 173c, and the third drain electrode 175c form a third thin-film transistor Qc together with the third semiconductor 154c. A channel of the third thin-film transistor Qc is formed in the third semiconductor 154c between the third source electrode 173c and the third drain electrode 175c.

The second drain electrode 175b is connected with the third source electrode 173c, and includes a widely expanded portion 177.

A first passivation layer 180p is formed on the data conductors 171, 173c,175a, 175b, and 175c and exposed portions of the semiconductors 154a, 154b, and 154c. The first passivation layer 180p may include an inorganic insulating layer, such as a silicon nitride or a silicon oxide. The first passivation layer 180p may prevent a pigment of a color filter 230 from flowing into exposed portions of the semiconductors 154a, 154b, and 154c.

The color filter 230 is formed on the first passivation layer 180p. The color filter 230 extends in a vertical direction along two adjacent data lines. A shielding electrode 220 is formed on the first passivation layer 180p, an edge of the color filter 230, and the data line 171.

Alternatively, the color filter 230 may formed in the upper panel 200, rather than being formed in the lower panel 100.

A second passivation layer 180q is formed on the color filter 230.

The second passivation layer 180q may include an inorganic insulating layer, such as a silicon nitride or a silicon oxide. The second passivation layer 180q may prevent the color filter 230 from being lifted and suppress the contamination of the liquid crystal layer 3 from an organic material such as a solvent flowing from the color filter 230 to prevent defects, such as an afterimage, from being formed when a screen is driven.

A first contact hole 185a and a second contact hole 185b that respectively expose the first drain electrode 175a and the second drain electrode 175b are formed in the first passivation layer 180p and the second passivation layer 180q.

A third contact hole 185c that exposes a portion of the reference electrode 137 and a portion of the third drain electrode 175c is formed in the first passivation layer 180p, the second passivation layer 180q, and the gate insulating layer 140. A connection member 195 may cover the third contact hole 185c. The connection member 195 electrically connects the reference electrode 137 and the third drain electrode 175c that are exposed through the third contact hole 185c.

Pixel electrodes 191 are formed on the second passivation layer 180q. The pixel electrodes 191 are separated from each other, interposing the gate line 121 therebetween, and include a first subpixel electrode 191a and a second subpixel electrode 191b that neighbor each other in a column direction with reference to the gate line 121. The pixel electrode 191 may include a transparent material, such as indium tin oxide (ITO) and indium zinc oxide (IZO). Alternatively, the pixel electrode 191 may be made of a reflective metal, such as aluminum, silver, chromium, or an alloy thereof.

The first subpixel electrode 191a and the second subpixel electrode 191b respectively include one or more of basic electrodes or variations of the basic electrode shown in FIG. 4.

The first subpixel electrode 191a and the second subpixel electrode 191b are physically and electrically connected to the first drain electrode 175a and the second drain electrode 175b, respectively, through the first contact hole 185a and the second contact hole 185b, and receive data voltages from the first drain electrode 175a and the second drain electrode 175b. In this case, a portion of the data voltage applied to the second drain electrode 175b is divided through the third source electrode 173c,and thus the voltage applied to the first subpixel electrode 191a is higher than the voltage applied to the second subpixel electrode 191b.

The first subpixel electrode 191a and the second subpixel electrode 191b to which the data voltages are applied generate an electric field together with a common electrode 270 of the upper panel 200 to determine a direction of the liquid crystal molecules 31 of the liquid crystal layer 3 between the two electrodes 191 and 270. Luminance of light passing through the liquid crystal layer 3 varies according to the determined directions of the liquid crystal molecules 31.

Next, the upper panel 200 will be described.

A black matrix 220 is formed on an insulation substrate 210. The black matrix 220 is formed in the upper panel 200 corresponding to a region where the data line of the lower panel 100 is formed and a region where the transistor is formed.

An overcoat 250 is formed on the black matrix 220. The overcoat 250 may be omitted.

The common electrode 270 is formed on the overcoat 250. An upper alignment layer (not shown) is formed on the common electrode 270. The upper alignment layer may be a vertical alignment layer.

The liquid crystal layer 3 may have negative dielectric anisotropy, and liquid crystal molecules 31 of the liquid crystal layer 3 are aligned so that long axes thereof are perpendicular to the surfaces of the two panels 100 and 200 when an electric field is not applied.

In addition, although not illustrated, the lower polarizer may be arranged below the lower panel 100, and the upper polarizer may be arranged above the upper panel 200. The polarizers polarize incident light from a backlight unit (not shown) in a constant direction and transmit the polarized light into the liquid crystal display, and re-polarize the light passed through the liquid crystal display in a constant direction to emit the polarized light to the outside of the liquid crystal display.

Next, the shape of the pixel electrode of the liquid crystal display according to the exemplary embodiment of the present invention will be described with reference to FIG. 4. The shapes of the first subpixel electrode and the second subpixel electrode may substantially be similar to the shape of the pixel electrode.

Referring to FIG. 4, the entire shape of the pixel electrode 191 is a quadrangle (or a rectangle), and includes a first diagonal stem 192 and a second diagonal stem 193 that crosses the first diagonal stem 192. More particularly, the diagonal stems 192 and 193 may cross each other to form an X shape in the pixel electrode 191.

When the pixel electrode 191 has a square shape, the first diagonal stem 192 and the second diagonal stem 193 may perpendicularly cross each other.

The pixel electrode 191 is divided into a first sub-region Da, a second sub-region Db, a third sub-region Dc, and a fourth sub-region Dd by the first diagonal stem 192 and the second diagonal stem 193 that crosses the first diagonal stem 192. Sub-regions Da, Db, Dc, and Dd may include first minute branches 194a, second minute branches 194b, third minute branches 194c, and fourth minute branches 194d, respectively.

An outer edge stem may be formed at an edge of each of the minute branches to connect edges of the respective minute branches.

The first minute branches 194a may extend straight upwards from a crossing portion of the first diagonal stem 192 and the second diagonal stem 193. The third minute branches 194c may extend straight downwards from the crossing point of the first diagonal stem 192 and the second diagonal stem 193.

The second minute branches 194b may extend in the rightward direction from the crossing point of the first diagonal stem 192 and the second diagonal stem 193. The fourth minute branches 194a may extend in the leftward direction from the crossing point of the first diagonal stem 192 and the second diagonal stem 193.

The first minute branches 194a and the third minute branches 194c may form an angle of about 90 degrees with the gate line 121, and be substantially parallel to the data line 171. More particularly, the first minute branches 194a and the third minute branches 194c may form an angle of 80 degrees to 100 degrees with an extension direction of the gate line 121.

The second minute branches 194b and the fourth minute branches 194d may form an angle of about 90 degrees with the data line 171, and may be substantially parallel to the gate line 121. That is, the second minute branches 194b and the fourth minute branches 194d may form an angle of −10 degrees to 10 degrees with respect to an extension direction of the gate line 121.

Referring to FIG. 4, the minute branches 194a, 194b, 194c, and 194d may perpendicularly cross corresponding minute branches 194a, 194b, 194c, and 194d of neighboring sub-regions of Da, Db, Dc, and Dd.

The width of each of the minute branches 194a, 194b, 194c, and 194d may be in the range of 2.5 μm to 5.0 μm, and a gap between neighboring minute branches 194a, 194b, 194c, and 194d within a sub-region (Da, Db, Dc, or Dd) may be in the range of 2.5μm to 5.0 μm.

The first subpixel electrode 191a and the second subpixel electrode 191b are respectively connected to the first drain electrode 175a or the second drain electrode 175b through the first contact hole 185a and the second contact hole 185b, and receive data voltages from the first drain electrode 175a and the second drain electrode 175b. In this case, sides of the first to fourth minute branches 194a, 194b, 194c, and 194d may distort an electric field to generate horizontal components that determine a tilting direction of the liquid crystal molecules 31. The horizontal components of the electric field are substantially horizontal to the sides of the first to fourth minute branches 194a, 194b, 194c, and 194d. Therefore, as shown in FIG. 4, the liquid crystal molecules 31 may be tilted in a direction parallel to a length direction of the minute branches 194a, 194b, 194c, and 194d. Since one pixel electrode 191 includes four sub-regions Da, Db, Dc, and Dd in which length directions of the minute branches 194a, 194b, 194c, and 194d are different from each other, the liquid crystal molecules 31 may be tilted in four different directions, and four different domains each having different alignment directions of the liquid crystal molecules 31 may be formed in the liquid crystal layer 3. When a tilted direction of the liquid crystal molecules 31 varies according to the present exemplary embodiment, a reference viewing angle of the liquid crystal display may increase.

Next, a method of pre-tilting the liquid crystal molecules 31 will be described with reference to FIG. 5.

FIG. 5 shows a process in which the liquid crystal molecules form pre-tilts by using a pre-polymer that is polymerized by light, such as ultraviolet rays.

A pre-polymer 33, such as a monomer, cured by polymerization with light, such as ultraviolet rays, is injected together with a liquid crystal material between the two panels 100 and 200. The pre-polymer 33 may be a reactive mesogen polymerized by light such as ultraviolet light.

Next, a data voltage is applied to the first subpixel electrode 191a and the second subpixel electrode 191b, and a common voltage is applied to the common electrode 270 to generate an electric field in the liquid crystal layer 3 between the two panels 100 and 200. In response to the electric field applied, the liquid crystal molecules 31 of the liquid crystal layer 3 may be tilted in a direction that is parallel to the length directions of the minute branches 194a, 194b, 194c, and 194d, and the liquid crystal molecules 31 are tilted in four directions in one pixel.

When light such as ultraviolet rays is irradiated to the liquid crystal layer 3 after the electric field is generated, the pre-polymer 33 may be polymerized to form a polymer 370 as shown in FIG. 5. The polymer 370 is formed to contact the panels 100 and 200. The liquid crystal molecules 31 are pre-tilted in a direction parallel to the length directions of corresponding minute branches by the polymer 370. Thus, the liquid crystal molecules 31 may have pre-tilts in four different directions even when no voltage is applied to the field generating electrodes 191 and 270.

Next, a polarizer of the liquid crystal display according to an exemplary embodiment of the present invention will be described. The polarizer includes a lower polarizer disposed below the lower panel 100 and an upper polarizer disposed above the upper panel 200.

The polarizer polarizes incident light in a constant direction and transmits the polarized light into the liquid crystal display through the lower polarizer, or polarizes light passing through the liquid crystal display in a constant direction and emits the polarized light to the outside of the liquid crystal display through the upper panel.

The polarizer may have a transmissive axis that transmits light only in a predetermined direction. The polarizer may have high transmittance when the transmissive axis and the minute branches form an angle of 45 degrees. The upper polarizer and the lower polarizer of the liquid crystal display according to the present exemplary embodiment each have a transmissive axis and minute branches forming 45 degrees with each other..

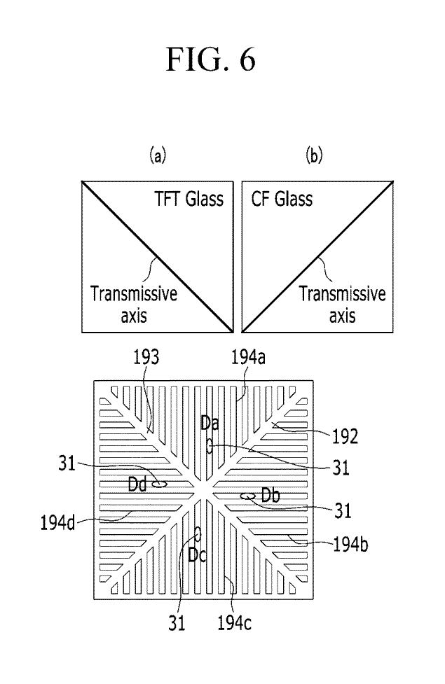

FIG. 6 shows the transmissive axes of the lower and upper polarizers of the liquid crystal display according to the exemplary embodiment of the present invention. In FIG. 6,(a) shows the lower polarizer and (b) shows the upper polarizer.

Referring to FIG. 6, the transmissive axis is formed in a first diagonal direction in the lower polarizer, and the transmissive axis of the upper polarizer is formed in a second diagonal direction that crosses the transmissive axis of the lower polarizer.

More particularly, the transmissive axis of the lower polarizer and the transmissive axis of the upper polarizer of the liquid crystal display according to the present exemplary embodiment are respectively formed to be in the same direction as those of the first diagonal stem 192 and the second diagonal stem 193.

Thus, the respective minute branches and the transmissive axes may form an angle of 45 degrees or substantially 45 degrees. When the angle between the transmissive axes and the minute branches is 45 degrees, high transmittance may be achieved to increase transmittance of the liquid crystal display.

As described above, in the liquid crystal display according to the exemplary embodiment of the present invention, the minute branches of the pixel electrode are respectively formed in vertical and horizontal directions, and the transmissive axes of the polarizers are formed in diagonal directions. In the liquid crystal display of the present exemplary embodiment, a domain boundary of the pixel electrode exists in the diagonal line, and liquid crystal molecules 31 of each domain are aligned at 0 degrees and 90 degrees with respect to the liquid crystal display, to reduce generation of a texture from misalignment when the liquid crystal display is bent.

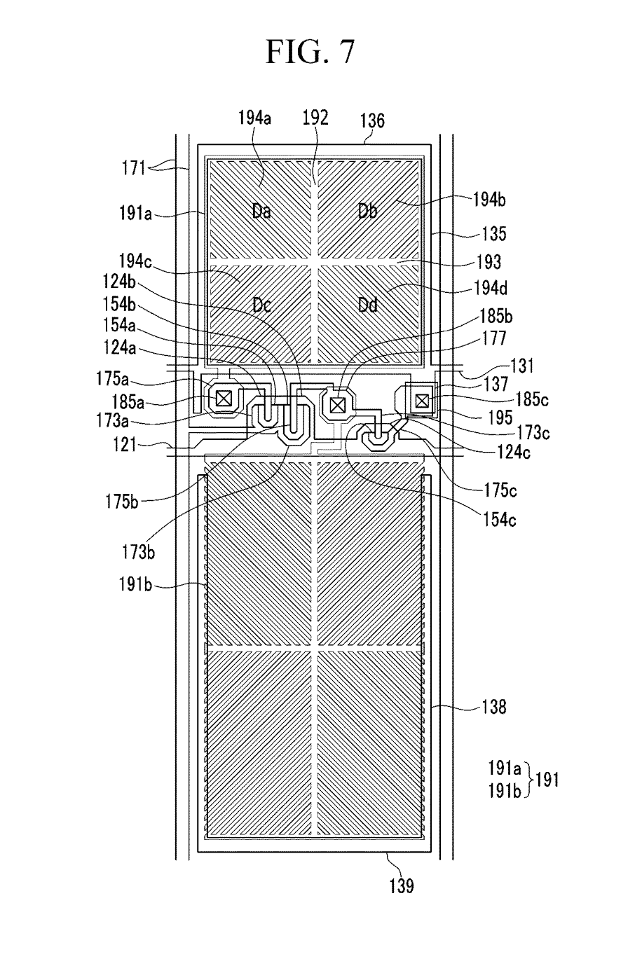

Such an effect of the present exemplary embodiment will be described in detail with reference to a comparative exemplary embodiment. FIG. 7 is a layout view of a liquid crystal display according to the comparative embodiment. The liquid crystal display illustrated in FIG. 7 has elements substantially similar to the liquid crystal display illustrated with respect to FIG. 2, and repeated description of the substantially similar elements and operations will be omitted.

However, in the liquid crystal display of FIG. 7, horizontal stems and vertical stems 192 and 193 that become domain boundaries of a pixel electrode are formed to have a cross shape, and minute branches 194a, 194b, 194c, and 194d of each domain regions Da, Db, Dc, and Dd are formed in a diagonal direction with respect to the cross-shaped stems 192 and 193. More particularly, the minute branches 194a, 194b, 194c, and 194d are formed in a direction of 45 degrees or 135 degrees with respect to the cross-shaped stems 192 and 193.

When the liquid crystal display according to the comparative exemplary embodiment illustrated in FIG. 7 is bent, a misalignment may occur due to a curvature difference between a lower panel 100 and an upper panel 200. Such misalignment may generate texture.

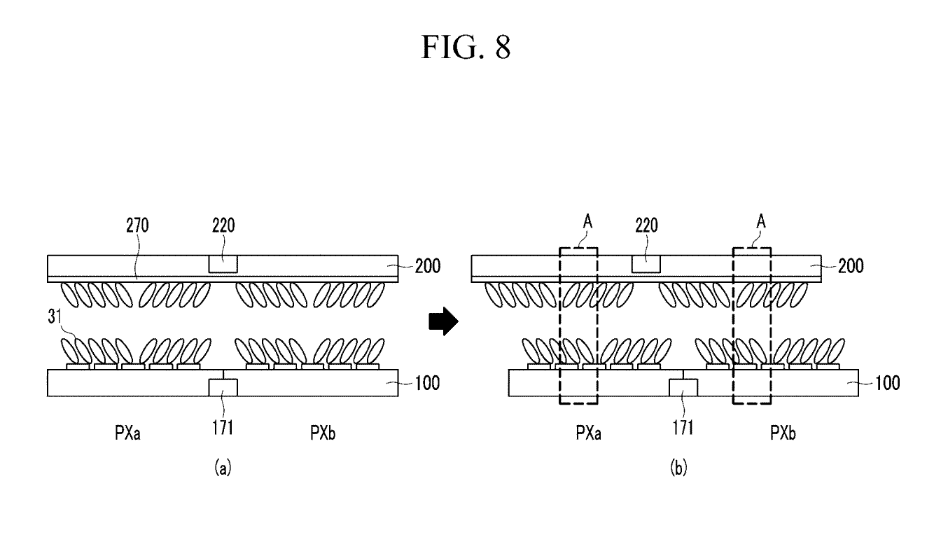

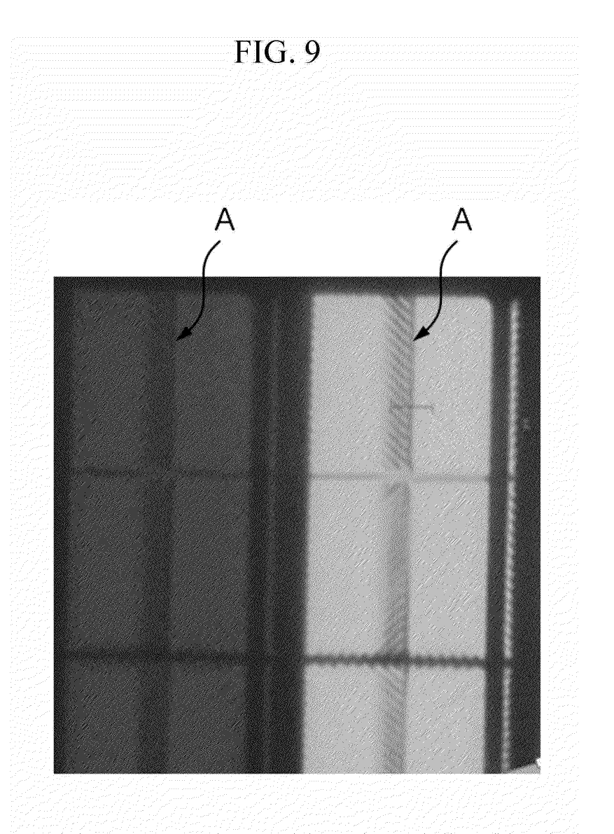

FIG. 8 is a diagram illustrating a misalignment and texture generation when the liquid crystal display of FIG. 7 is bent. FIG. 9 is an image illustrating substantially generated texture.

In FIG. 8,(a) is a cross-sectional view of the liquid crystal display of FIG. 7 before being bent, and (b) is a cross-sectional view of the liquid crystal display of FIG. 7 after being bent, according to the comparative exemplary embodiment.

Referring to FIG. 8(a), the liquid crystal display includes an area forming a data line 171 in a lower panel 100 and an area forming a black matrix 220 in an upper panel 200 that correspond to each other, and liquid crystal molecules 31 in each of pixels PXa and PXb are tilted in a direction toward a domain formed in each minute branch.

Referring to FIG. 8(b), when the liquid crystal display is bent, a location of the data line 171 of the lower panel 100 and a location of the black matrix 220 of the upper panel 200 may not correspond to each other. More particularly, each domain is shifted to form “A” areas as illustrated in (b) of FIG. 8. In the “A” areas, alignment directions of liquid crystal molecules 31 may be different from each other.

The alignment directions of the liquid crystal molecules 31 between neighboring domains may be different from each other as the liquid crystal molecules 31 intrude to a boundary of each domain. In the “A” areas, the difference in alignment directions of the liquid crystal molecules 31 may generate a texture.

In FIG. 9, dark portions indicated as “A” illustrate areas of FIG. 8(b) where the texture is generated.

However, in the liquid crystal display according to the exemplary embodiment of the present invention, the liquid crystal molecules in the neighboring domains (up-and-down, left-and-right) are aligned to be in the same direction with each other. More particularly, as shown in FIG. 4, the alignment directions of the liquid crystals in the domain Da and the liquid crystals in the domain Dc neighbor each other in the up-and-down direction and are parallel to each other, and the alignment directions of the liquid crystals in the domain Db and the liquid crystals in the domain Dd neighbor each other in the left-and-right direction and are parallel with each other.

Thus, when the liquid crystal display according to the present exemplary embodiment is horizontally bent, the alignment directions of the liquid crystal molecules 31 may not change significantly, thereby preventing generation of a texture.

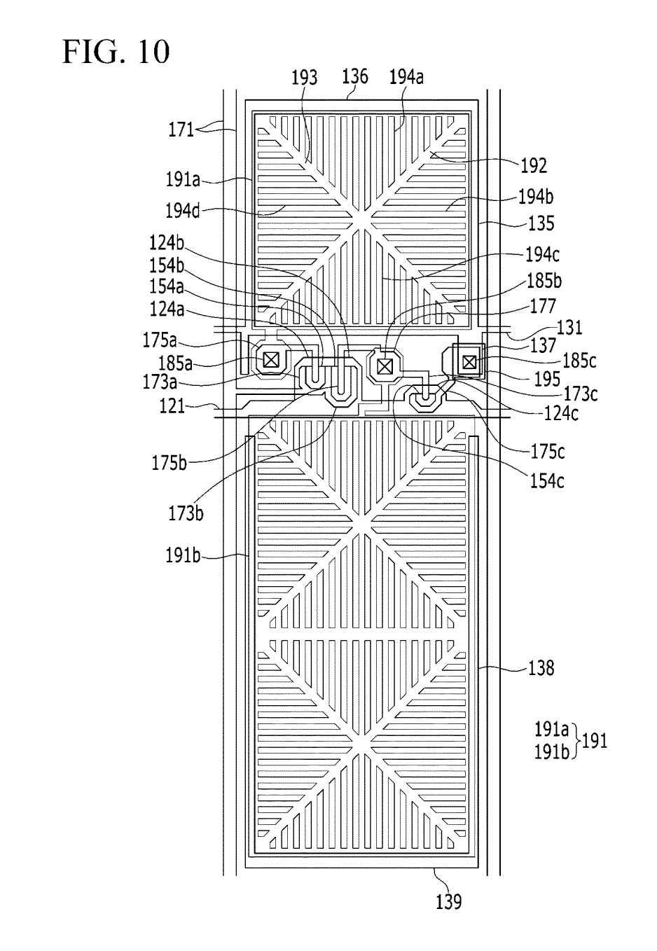

FIG. 10 shows a liquid crystal display according to an exemplary embodiment of the present invention. Referring to FIG. 10, the liquid crystal display of FIG. 10 has elements substantially similar to the liquid crystal display illustrated with respect to FIG. 2, and therefore, repeated description of the substantially similar elements and operations will be omitted.

In the liquid crystal display of FIG. 10, a second subpixel electrode 191b includes two pixel unit electrodes, rather than one pixel unit electrode as illustrated in FIG. 4.

In this case, the shape of each pixel unit electrode in the second subpixel electrode 191b is substantially similar to the shape of the pixel unit illustrated in FIG. 4. A description of the substantially similar elements will be omitted.

In the liquid crystal display of FIG. 2, the diagonal stems 192 and 193 in the second subpixel electrode 191b forming the cross shape may not perpendicularly cross each other since the second subpixel electrode 191b has a rectangle shape, the vertical length of the second subpixel electrode 191b is longer than the horizontal length.

In the liquid crystal display of FIG. 10, however, the second subpixel electrode 191b is formed of two pixel unit electrodes, and each pixel unit electrode has a square shape.

Thus, two diagonal stems 192 and 193 in the second subpixel electrode 191b are formed to cross each other to have an X shape. Accordingly, an angle formed by the diagonal stems 192 and 193 and the minute branches 194a, 194b, 194c, and 194d may become about 45 degrees in the entire pixel area.

In the entire area of the display device, an angle formed by transmissive axes of polarizers and minute branches 194a, 194b, 194c, and 194d may be 45 degrees to increase transmittance.

The liquid crystal display according to the exemplary embodiments of the present invention is described to be driven by the circuit shown in FIG. 1. In the following description, various driving methods that may be applied to the liquid crystal display will be described.

More particularly, the following exemplary embodiments will describe a change in voltage levels of two subpixel electrodes with a circuit diagram.

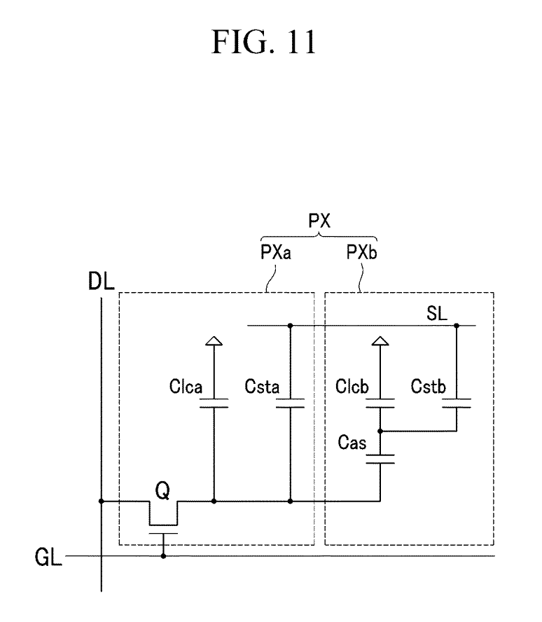

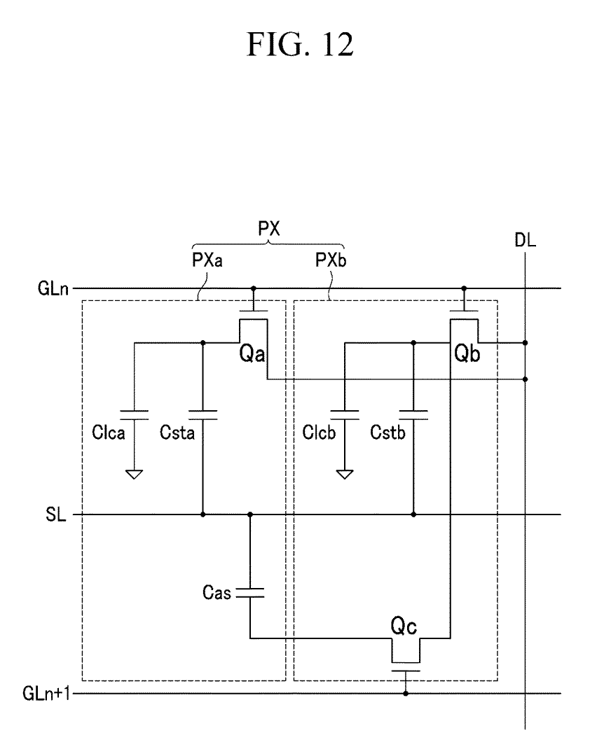

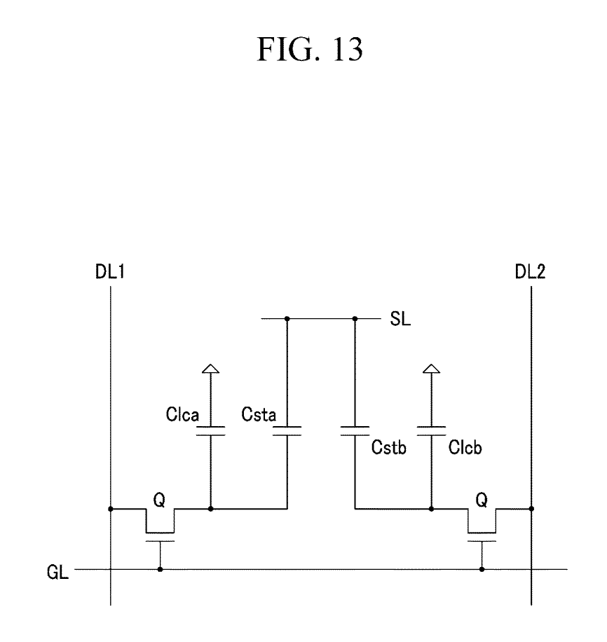

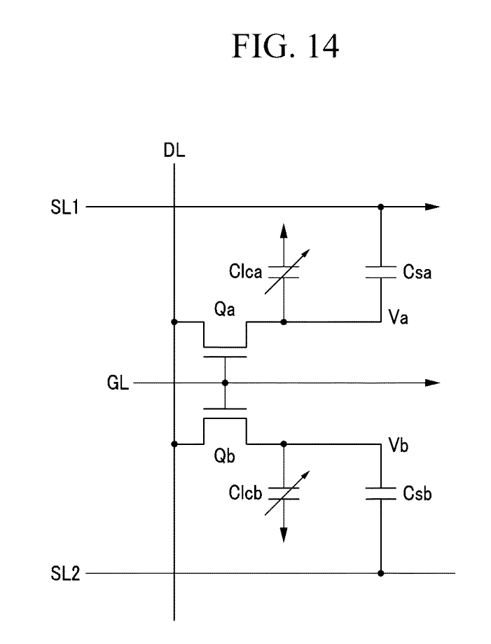

FIG. 11 to FIG. 14 are circuit diagrams of a pixel according to exemplary embodiments of the present invention.

First, a circuit diagram according to an exemplary embodiment of the present invention will be described with reference to FIG. 11.

A liquid crystal display according to an exemplary embodiment of the present invention illustrated in FIG. 11 includes signal lines including gate lines GL, data lines DL, and storage electrode lines SL, and pixels PX connected to the signal line. Each pixel PX includes a pair of first and second subpixels PXa and PXb, in which a first subpixel electrode is formed in the first subpixel PXa and a second subpixel electrode is formed in the second subpixel PXb.

The liquid crystal display according to the present exemplary embodiment further includes a switching element Q connected to the gate line GL and the data line DL, a first liquid crystal capacitor Clca and a first storage capacitor Csta connected to the switching element Q and formed in the first subpixel PXa, a second liquid crystal storage Clcb and a second storage capacitor Cstb connected to the switching element Q and formed in the second subpixel PXb, and an auxiliary capacitor Cas formed between the switching element Q and the second liquid crystal capacitor Clcb.

The switching element Q is a three-terminal element such as a thin-film transistor provided in a lower panel 100, and a control terminal thereof is connected to the gate line GL, an input terminal thereof is connected with the data line DL, and an output terminal thereof is connected to the first liquid crystal capacitor Clca, the first storage capacitor Csta, and the auxiliary capacitor Cas.

A first terminal of the auxiliary capacitor Cas is connected to the output terminal of the switching element Q, and a second terminal of the auxiliary capacitor Cas is connected to the second liquid crystal capacitor Clcb and the second storage capacitor Cstb.

A charging voltage of the second liquid crystal capacitor Clcb becomes lower than a charging voltage of the first liquid crystal capacitor Clca by the auxiliary capacitor Cas, to improve side visibility of the liquid crystal display.

Hereinafter, a circuit diagram according to an exemplary embodiment of the present invention will be described with reference to FIG. 12.

A liquid crystal display according to the present exemplary embodiment includes signal lines including gate lines GLn and GLn+1, data lines DL, and storage electrode lines SL, and pixels PX connected to the signal line. Each pixel PX includes a pair of first and second subpixels PXa and PXb, and a first subpixel electrode is formed in the first subpixel PXa and a second subpixel electrode is formed in the second subpixel PXb.

The liquid crystal display according to the present exemplary embodiment further includes a first switching element Qa and a second switching element Qb connected to the gate line GLn and the data line D1, a first liquid crystal capacitor Clca and a first storage capacitor Csta connected to the first switching element Qa and formed in the first subpixel PXa, a second liquid crystal capacitor Clcb and a second storage capacitor Cstb connected to the second switching element Qb and formed in the second subpixel PXb, a third switching element Qc connected with the second switching element Qb and switched by the next gate line GLn+1m, and an auxiliary capacitor Cas connected to the third switching element Qc.

The first switching element Qa and the second switching element Qb are three-terminal elements, such as thin-film transistors arranged at the lower display panel 100. Control terminals thereof are connected to the gate lines GLn, input terminals thereof are connected to the data lines DL, and output terminals thereof are connected to the first liquid crystal capacitor Clca and the first storage capacitor Csta, and the second liquid crystal capacitor Clcb and the second storage capacitor Cstb, respectively.

The third switching element Qc also corresponds to the three-terminal element, such as the thin-film transistor arranged at the lower display panel 100. A control terminal is connected to the next gate line GLn+1, an input terminal is connected to the second liquid crystal capacitor Clcb, and an output terminal is connected to the auxiliary capacitor Cas.

One terminal of the auxiliary capacitor Cas is connected to the output terminal of the third switching element Qc, and the other terminal is connected to the storage electrode line SL.

An operation of the liquid crystal display according to the exemplary embodiment of the present invention will now be described. When a gate on voltage is applied to the gate line GLn, the first switching element and second switching element Qa and Qb connected to the gate line GLn are turned on, and the data voltage of the data line 171 is applied to the first and second subpixel electrodes.

Subsequently, when a gate off voltage is applied to the gate line GLn and the gate on voltage is applied to the next gate line GLn+1, the first and second switching elements Qa and Qb are turned off and the third switching element Qc is turned on. Accordingly, a charge of the second subpixel electrode connected to the output terminal of the second switching element Qb flows in the auxiliary capacitor Cas, to drop the voltage of the second liquid crystal capacitor Clcb.

As described above, by making the charging voltages of the first and second liquid crystal capacitors Clca and Clcb different may improve the side visibility of the liquid crystal display.

Hereinafter an circuit diagram according to an exemplary embodiment of the present invention will be described with reference to FIG. 13.

A liquid crystal display according to the present exemplary embodiment includes signal lines including gate lines GL, data lines DL1 and DL2, storage electrode lines SL, and pixels PX connected to the signal lines. Each of the pixels PX includes a pair of first and second liquid crystal capacitors Clca and Clcb and a pair of first and second storage capacitors Csta and Cstb.

Each of the subpixels includes one liquid crystal capacitor and one storage capacitor, and further includes one thin-film transistor Q. The thin-film transistors Q of two subpixels included in one pixel are connected to the same gate line GL and different data lines DL1 and DL2. The different data lines DL1 and DL2 may simultaneously apply data voltages at different levels so that the first and second liquid crystal capacitors Clca and Clcb of the two subpixels have different charging voltages. As a result, the side visibility of the liquid crystal display may be improved.

Hereinafter, a circuit diagram according to an exemplary embodiment of the present invention will be described with reference to FIG. 14.

A liquid crystal display according to the present exemplary embodiment includes a gate line GL, a data line DL, a first power line SL1, a second power line SL2, and a first switching element Qa and a second switching element Qb connected to the gate line GL and the data line DL, as illustrated in FIG. 14.

The liquid crystal display according to the present exemplary embodiment further includes an auxiliary step-up capacitor Csa and a first liquid crystal capacitor Clca connected to the first switching element Qa, and an auxiliary step-down capacitor Csb and a second liquid crystal capacitor Clcb connected to the second switching element Qb.

The first switching element Qa and the second switching element Qb are formed with three-terminal elements, such as the thin-film transistor and the like. The first switching element Qa and the second switching element Qb are connected to the same gate line GL and the same data line DL, so as to be turned on at the same time and output the same data signal.

The first power line SL1 and the second power line SL2 are applied with a voltage having a swing in a predetermined period. A first low voltage is applied to the first power line SL1 for a predetermined period and a first high voltage is applied to the first power line SL1 for a next predetermined period. A second high voltage is applied to the second power line SL2 for a predetermined period, and a second low voltage is applied to the second power line SL2 for a next predetermined period. In this case, the first period and the second period are repeated several times during one frame, and thus the first power line SL1 and the second power line SL2 are applied with the swing voltage. The first low voltage and the second low voltage may be the same, and the first high voltage and the second high voltage may also be the same.

The auxiliary step-up capacitor Csa is connected to the first switching element Qa and the first power line SL1, and the auxiliary step-down capacitor Csb is connected to the second switching element Qb and the second power line SL2.

A voltage Va of a terminal (hereinafter referred to as a “first terminal”) where the auxiliary step-up capacitor Csa is connected to the first switching element Qa becomes lower when the first low voltage is applied to the first power line SL1, and becomes higher when the first high voltage is applied to the first power line SL1. Thereafter, as the voltage of the first power line SL1 swings, the voltage Va of the first terminal may also swing.

Further, a voltage Vb of a terminal (hereinafter referred to as a “second terminal”) where the auxiliary step-down capacitor Csb is connected to the first switching element Qa becomes higher when the second high voltage is applied to the second power line SL2, and becomes lower when the second low voltage is applied to the second power line SL2. Thereafter, as the voltage of the second power line SL2 swings, the voltage Vb of the second terminal may also swing.

As described above, since the voltages Va and Vb of the pixel electrodes of the two subpixels are changed according to sizes of the voltages that swing in the first and second power lines SL1 and SL2 even though the same data voltage is applied to the two subpixels, the transmittances of the two subpixels may become different from each other to improve the side visibility of the liquid crystal display.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A liquid crystal display, comprising:
a first substrate;
a gate line disposed on the first substrate;
an insulating layer disposed on the gate line;
a pixel electrode disposed on the insulating layer, the pixel electrode comprising diagonal stems forming a cross shape with each other; and
minute branches extending in four different directions from the diagonal stems,
wherein:
the minute branches extend in first and second directions to form an angle of 80 degrees to 100 degrees with respect to an extension direction of the gate line; and
the minute branches extend in third and fourth directions to form an angle of −10 degrees to 10 degrees with respect to the extension direction of the gate line.

2. The liquid crystal display of claim 1, wherein the pixel electrode comprises a first subpixel electrode and a second subpixel electrode spaced apart from each other.

3. The liquid crystal display of claim 2, wherein the first subpixel electrode is disposed above the gate line and the second subpixel is disposed below the gate line.

4. The liquid crystal display of claim 3, wherein an area of the second subpixel electrode is greater than an area of the first subpixel electrode.

5. The liquid crystal display of claim 4, wherein:
the first subpixel electrode comprises the diagonal stems forming one cross shape;
the second subpixel electrode comprises the diagonal stems forming two cross shapes; and
the diagonal stems forming each cross shape cross each other perpendicularly at a crossing point.

6. The liquid crystal display of claim 1, wherein:
the diagonal stems divide the pixel electrode into a first region, a second region, a third region, and a fourth region; and
the minute branches in the regions that face each other with respect to the diagonal stems extend in the same direction.

7. The liquid crystal display of claim 6, wherein:
the minute branches in the first and third regions are disposed in the same direction;
the minute branches in the second and fourth regions are disposed in the same direction; and
the minute branches of the first and second regions are disposed to be perpendicular to each other.

8. The liquid crystal display of claim 1, further comprising:
a second substrate disposed to face the first substrate;
a common electrode disposed on the second substrate; and
a liquid crystal layer disposed between the first substrate and the second substrate.

9. The liquid crystal display of claim 8, further comprising:
a lower polarizer disposed below the first substrate; and
an upper polarizer disposed above the second substrate.

10. The liquid crystal display of claim 9, wherein:
a transmissive axis of the lower polarizer is substantially parallel to a first extending direction of the diagonal stems;
a transmissive axis of the upper polarizer is substantially parallel to a second extending direction of the diagonal stems; and
the transmissive axes of the lower and upper polarizers cross each other to form an X shape.

11. The liquid crystal display of claim 10, wherein the transmissive axis of the lower polarizer and the minute branches form an angle of 45 degrees.

12. The liquid crystal display of claim 10, wherein the transmissive axis of the upper polarizer and the minute branches form an angle of 45 degrees.

13. The liquid crystal display of claim 10, wherein the transmissive axis of the upper polarizer and the transmissive axis of the lower polarizer perpendicularly cross each other.

14. The liquid crystal display of claim 1, wherein the liquid crystal display is a curved display.

15. The liquid crystal display of claim 2, wherein the first subpixel electrode is configured to receive a first voltage and the second subpixel electrode is configured to receive a second voltage different from the first voltage.

16. The liquid crystal display of claim 2, wherein the first subpixel electrode is configured to receive a first voltage and the second subpixel electrode is configured to receive a second voltage lower than the first voltage.

17. The liquid crystal display of claim 1, wherein each edge of the minute branches is connected to an outer edge stem.

18. The liquid crystal display of claim 5, wherein the two cross shapes disposed in the second subpixel electrode have the same shape with each other and are spaced apart by a horizontal stem forming an angle of 45 degrees with the diagonal stems.

19. The liquid crystal display of claim 1, wherein a width of each minute branches is in a range of 2.5 μm to 5.0 μm.

20. The liquid crystal display of claim 1, wherein a distance between minute branches extending in the same direction is in a range of 2.5 μm to 5.0 μm.
